(19) United States
(12) Patent Application Publication
(10) Pub. No.: US 2011/0310045 A1
(43) Pub. Date: Dec. 22, 2011

(54) PORTABLE TERMINAL DEVICE AND INPUT DEVICE

(75) Inventors: Hiroshi Toda, Kanagawa (JP); Mitsuru Satou, Kanagawa (JP); Hidekazu Kano, Tokyo (JP)

(73) Assignee: Panasonic Corporation, Osaka (JP)

(21) Appl. No.: 13/203,913

(22) PCT Filed: Nov. 16, 2009
(86) PCT No.: PCT/JP2009/006138

§ 371 Date: Aug. 30, 2011

(30) Foreign Application Priority Data
Mar. 2, 2009 (JP) 2009-047926

(51) Int. Cl. G06F 3/041

(52) U.S. Cl. 345/173

(57) ABSTRACT

An input indication corresponding to operation intended by a user in a touch pad can be conducted, and operability can be improved. A tip coordinate Y of a touch region is calculated by a tip coordinate calculation unit 21 and a center coordinate y of the touch region is calculated by a center coordinate calculation unit 22 on the basis of touch information associated with a touch pad 16 which is detected by a detection unit 17. A determination unit 23 determines whether or not there is a travel of the touch region, and the travel distance calculation unit 24 calculates a travel distance of a touch point with the use of the tip coordinate Y or the center coordinate y on the basis of the determination result. When the touch region travels, the travel distance is calculated by the tip coordinates, and when the stop time, the separating time, and the touch start time of the touch region, the travel distance is calculated according to the center coordinates. The coordinate output unit 25 outputs relative coordinates and absolute coordinates as the indicated coordinates indicative of a specific position corresponding to touch operation on a touch pad 16.

### TECHNICAL FIELD

The present invention relates to a portable terminal device having a touch pad for conducting an input indication, and an input device including the touch pad.

### BACKGROUND ART

A variety of electronic devices such as cellular phone devices, personal digital assistants, or portable audio players have been advanced in performance, multifunction, and a reduction in size as with PCs (personal computers). In order to respond to such advanced electronic devices, the input device for the input indication is variously devised. In recent years, the input device for the electronic device having a touch pad where an input indication is made by touching an arbitrary position on a control pad has been increasingly widespread.

When the touch pad is used for the input operation, detailed operation is hard to conduct, and it may be difficult to travel a cursor to a desired position, or touch a desired position. In particular, when a user trails his thumb on the touch pad while gripping a portable terminal device such as a cellular phone device, there may occur such a drawback that a cursor does not satisfactorily travel, or does not satisfactorily stop.

In order to improve the operability of the touch pad, for example, Patent Document 1 discloses a coordinate input device in which center coordinates of a touch region touched by a finger of the user are determined as representative coordinates, an increase rate of the area in the touch region is detected, and when the detected increase rate of the area is equal to a given reference area increase rate or greater, the representative coordinates are corrected to determine output coordinates.

In the conventional example, it is determined whether the representative coordinates are corrected, or not, according to the increase rate of the area in the touch region to determine the output coordinates, thereby determining a subsequent motion of the indicated coordinates of an operating point of the cursor. This results in such a problem that a complicated operation is necessary, and it takes time to determine the coordinates. Also, there arises such a problem that when the cursor is traveled by the operation of trailing a finger, the cursor may not stop even if the cursor is tried to stop suddenly, and a response to the operation is not high.

### PRIOR ART DOCUMENT

Patent document

Patent Document 1: JP-A-2008-191791

### SUMMARY OF THE INVENTION

### Problem to be Solved by the Invention

In the conventional input device using the touch pad including the input device disclosed in the above Patent document 1, a gravity center (center of the touch region) of the finger touch portion is obtained to determine the indicated coordinates of the operating point, which are the representative coordinates. For that reason, the operation intended by the user may not match the indicated coordinates and the operating direction of an operating point that is really output, depending on how the user operates. In particular, when the touch pad is operated by his thumb, there arise such drawbacks that the indicated coordinates of the output operating point output may deviate from the user's intention, and also the operating point may travel in a direction opposite to the intended direction.

The present invention has been made under the above circumstances, and an object of the present invention is to provide a portable terminal device and an input device, which can conduct an input indication corresponding to operation intended by the user on a touch pad, and can improve the operability.

### Means for Solving the Problem

According to the present invention, there is provided a portable terminal device having a touch pad, comprising: a detection unit that detects a touch region on the touch pad; a tip coordinate calculation unit that calculates tip coordinates of the touch region; a center coordinate calculation unit that calculates center coordinates of the touch region; a determination unit that determines whether the touch region travels or not; a travel distance calculation unit that calculates a travel distance by the use of any one of the tip coordinates and the center coordinates on the basis of a determination result of the determination unit; and a coordinate output unit that outputs indicated coordinates for indicating a specific position corresponding to the touch operation on the touch pad with the use of the calculated travel distance.

With the above configuration, the travel distance is calculated with the use of any one of the tip coordinates and the center coordinates according to whether the touch region on the touch pad travels or not, and the indicated coordinates according to the user's intention can be output. Accordingly, the input indication corresponding to the operation intended by the user can be conducted on the touch pad, thereby enabling the operability to be improved.

Also, according to the present invention, in the above portable terminal device, the coordinate output unit includes a coordinate storage unit that stores the indicated coordinates therein, and a coordinate calculation unit which adds the travel distance calculated with the use of any one of the tip coordinates and the center coordinates to the indicated coordinates.

With the above configuration, the travel distance calculated by any one of the tip coordinates and the center coordinates according to a travel state of the touch region is added to the stored previous indicated coordinates. As a result, appropriate indicated coordinates corresponding to the touch operation on the touch pad can be output. In this case, the indicated coordinates can be output as absolute coordinates, or can be output as relative coordinates using the travel distance.

Also, according to the present invention, in the above portable terminal device, the travel distance calculation unit calculates the travel distance with the use of the tip coordinates when the touch region travels by a given amount or greater, and calculates the travel distance with the use of the center coordinates when the travel distance of the touch region is smaller than the given amount.

With the above configuration, a case in which the touch region travels by the given amount or greater is considered as when the operating point of the touch operation is traveling. The travel distance is calculated with the use of the tip coordinates so that the travel distance and the indicated coordinates indicative of the motion corresponding to the user's intention can be obtained. Also, a case in which the travel of the touch region is smaller than the given amount is considered as when the operating point of the touch operation stops. The travel distance is calculated with the use of the center coordinates so that stable indicated coordinates can be obtained without unnecessary motion.

Also, according to the present invention, in the above portable terminal device, the travel distance calculation unit calculates the travel distance with the use of the center coordinates when a width or area of the touch region is smaller than a first given value.

With the above configuration, a case in which the width or area of the touch region is smaller than the first given value is considered as a separation time or a touch start time of the user's finger, and the travel distance is calculated with the use of the center coordinates. As a result, the stable indicated coordinates can be obtained without unnecessary motion.

Also, according to the present invention, in the above portable terminal device, the travel distance calculation unit does not add the travel distance when the width or area of the touch region is smaller than a second given value which is smaller than the first given value.

With the above configuration, the travel distance is not added when the width or area of the touch region is smaller than the second given value which is smaller than the first given value. As a result, the stable indicated coordinates can be obtained without unnecessary motion.

Also, according to the present invention, in the above portable terminal device, there is provided a vertical direction detection unit that detects a vertical direction of the touch pad, and the tip coordinate calculation unit calculates the tip coordinates of the touch region on the basis of upper information detected by the vertical direction detection unit.

With the above configuration, the upper direction of the touch pad is detected so that the tip coordinates of the touch region can be appropriately calculated.

Also, according to the present invention, there is provided an input device for an electronic device having a touch pad, comprising: a detection unit that detects a touch region on the touch pad; a tip coordinate calculation unit s that calculates tip coordinates of the touch region; a center coordinate calculation unit that calculates center coordinates of the touch region; a determination unit that determines whether the touch region travels or not; a travel distance calculation unit that calculates a travel distance by the use of any one of the tip coordinates and the center coordinates on the basis of a determination result of the determination unit; and a coordinate output unit that outputs indicated coordinates for indicating a specific position corresponding to the touch operation on the touch pad with the use of the calculated travel distance.

### Advantages of the Invention

According to the present invention, there can be provided the portable terminal device and the input device that can conduct the input indication corresponding to the intended operation of the user on the touch pad, and can improve the operability.

### BRIEF DESCRIPTION OF THE DRAWINGS

FIG. 1 is a block diagram illustrating a configuration of a portable terminal device according to an embodiment of the present invention.

FIGS. 2(A) to 2(C) are diagrams illustrating an appearance in which a touch pad is traced with a thumb from top down.

FIG. 3 is a diagram illustrating a relationship between a change in a touch region and an operating point when the operation of FIGS. 2(A) to 2(C) is conducted.

FIGS. 4(A) to 4(C) are diagrams illustrating an appearance in which the touch pad is traced with the thumb from bottom up.

FIG. 5 is a diagram illustrating a relationship between a change in a touch region and an operating point when the operation of FIGS. 4(A) to 4(C) is conducted.

FIG. 6 is a block diagram illustrating a configuration of an operation input unit of a portable terminal device according to a first embodiment of the present invention.

FIG. 7 is a flowchart illustrating the operation of the operation input unit according to the first embodiment.

FIG. 8 is a block diagram illustrating a configuration of an operation input unit of a portable terminal device according to a second embodiment of the present invention.

### MODES FOR CARRYING OUT THE INVENTION

In the following embodiments, a configuration example in which a portable terminal device and an input device are applied to an electronic device such as a cellular phone device will be described. The portable terminal device and the input device are applicable to various electronic devices such as cellular phone devices, personal digital assistants, portable audio players, or remote controllers.

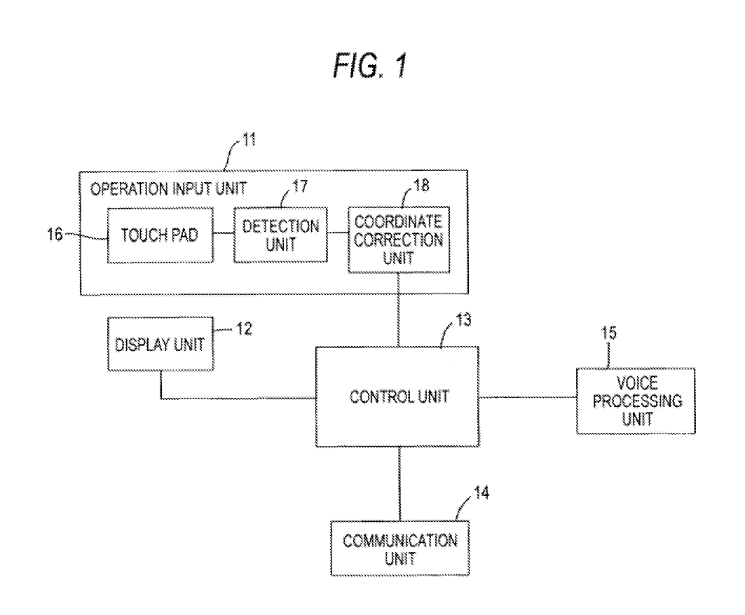

FIG. 1 is a block diagram illustrating a configuration of a portable terminal device according to an embodiment of the present invention. The portable terminal device includes an operation input unit 11, a display unit 12, a control unit 13, a communication unit 14, and a voice processing unit 15. The operation input unit 11 configures an input device of this embodiment, and includes a touch pad 16, a detection unit 17, and a coordinate correction unit 18.

The touch pad 16 is configured by a planar operation device such as a capacitance sensor, and outputs a signal representative of a position touched by the user. The detection unit 17 detects a touch region touched and operated by the user on the basis of an output signal from the touch pad 16, and outputs a detection result as touch information. The coordinate correction unit 18 corrects the indicated coordinates of the operating point touched by the user on the basis of the touch information detected by the detection unit 17. Then, the coordinate correction unit 18 outputs operation information such as indicated coordinates indicative of the operating point and a travel distance.

The display unit 12 is configured by a liquid crystal display device, and disposed at a lower portion of the touch pad 16, and displays respective operation screens to be operated by the touch pad 16, and other operation screens. The control unit 13 controls the respective units of the device, and inputs the operation information from the operation input unit 11 to conduct various signal processing, display control, and communication control. The communication unit 14 conducts communication processing corresponding to a communication line such as a cellular communication network. The communication unit 14 includes an RF unit, and a baseband processing unit. The communication unit 14 is appropriately configured according to corresponding communication means and communication system. The voice processing unit 15 conducts voice processing such as input and output of talk voice, and reproduction processing of music content. In this example, the control unit 13 and the coordinate correction unit 18 in the operation input unit 11 are each configured by a memory for storage of processing information, and a processor that conducts processing operation, and the respective functions are realized by execution of the processing according to a given program.

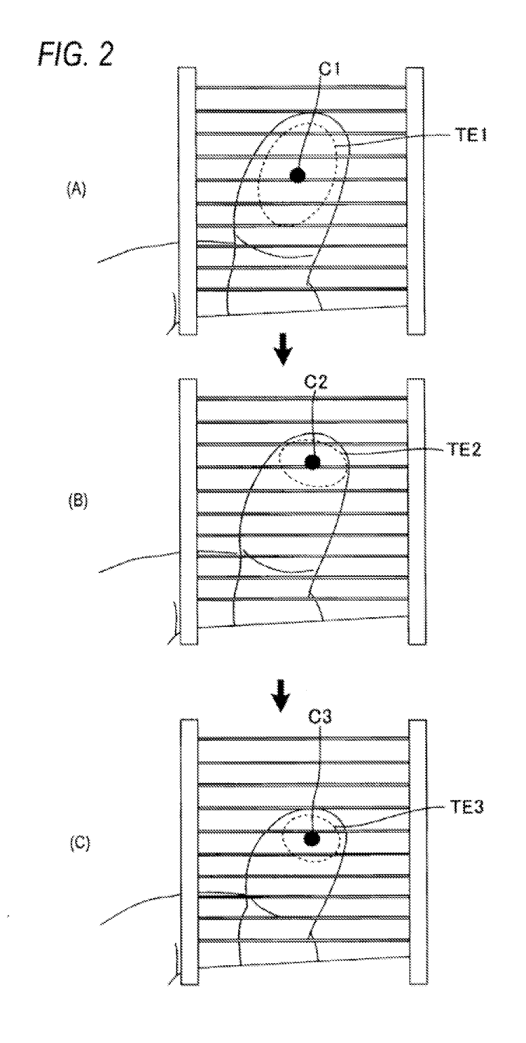

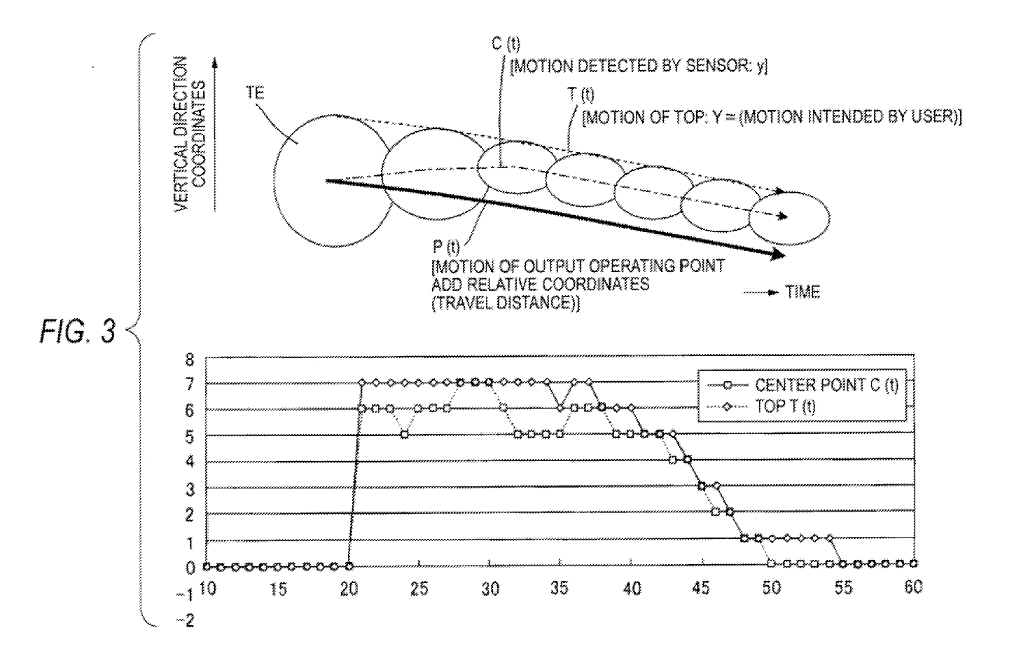

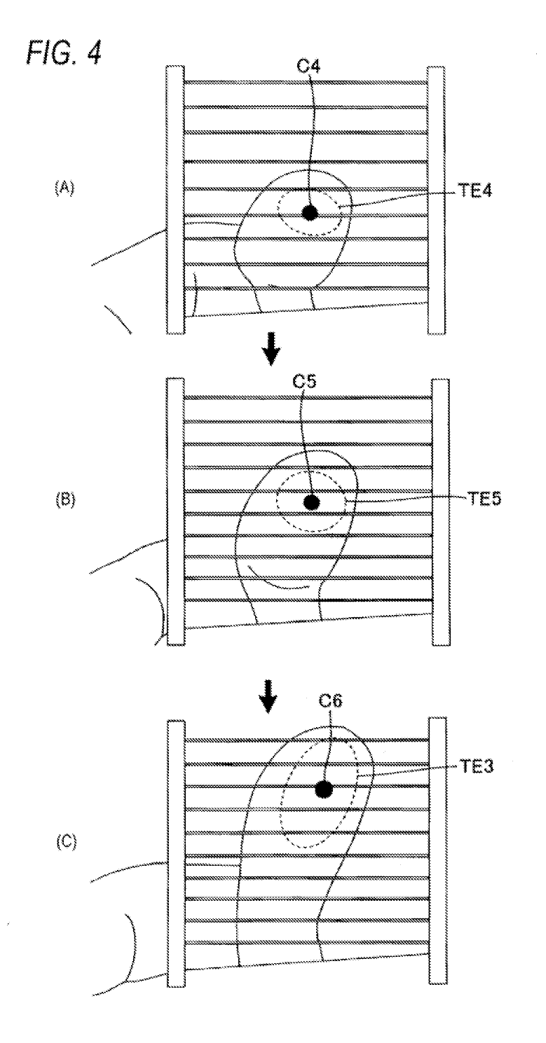

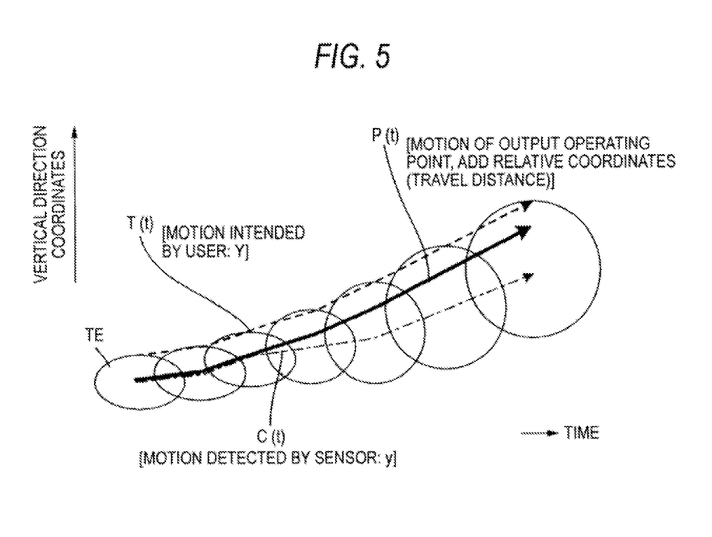

Subsequently, an outline of the operation of this embodiment will be described. FIGS. 2(A) to 2(C) are diagrams illustrating an appearance in which a touch pad is traced with a thumb from top down. FIG. 3 is a diagram illustrating a relationship between a change in a touch region and an operating point when the operation of FIGS. 2(A) to 2(C) is conducted. FIGS. 4(A) to 4(C) are diagrams illustrating an appearance in which the touch pad is traced with the thumb from bottom up. FIG. 5 is a diagram illustrating a relationship between a change in a touch region and an operating point when the operation of FIGS. 4(A) to 4(C) is conducted. A case in which the touch pad is operated by a thumb will be described as a typical example.

When the operation of tracing the touch pad with the thumb from top down is conducted as illustrated in FIG. 2, the touch region is changed in the order of TE1, TE2, and TE3 as indicated by FIGS. 2(A), 2(B), and 2(C). A center point (center of gravity) thereof is changed in the order of C1, C2, and C3. When the finger is going to be moved down, the thumb is first pushed at the time of starting the operation as illustrated in FIG. 2(A). Therefore, a touch area becomes the maximum. Then, as illustrated in FIG. 2(B), when the finger is moved down, a ball of the finger is lifted up, the touch area is gradually decreased, and the center point of the touch region is moved up. Then, as illustrated in FIG. 2(C), when the finger is moved, the finger is further erected, and the touch area becomes the minimum. The finger is moved down while keeping substantially a constant area.

FIG. 3 illustrates a change in the touch region corresponding to the operation of FIG. 2 with time. The axis of abscissa represents a time, and the axis of ordinates is coordinates of the vertical direction. In this example, it is assumed that the horizontal direction of the touch pad is an x-coordinate, and the vertical direction thereof is a Y-direction. In a change of a touch region TE, the motion of the indicated coordinates of the operating point which is detected by a sensor in the conventional touch pad corresponds to the motion of a center point C(t) which is the center of gravity in a touch region TE. In this case, when the motion of the center point C(t):y is viewed, despite a fact that the user moves his finger from top down, the center point C(t) is moved up once, and then moved down. Thus, the indicated coordinates of the operating point may be moved in a direction opposite to the intended direction. In order to solve this problem, in this embodiment, attention is paid to the coordinates of a top of the touch region TE. When the user operates the touch pad with his finger, the user is normally aware of a tip of the finger. Therefore, it is conceivable that the motion of a top T(t)of the touch region TE is close to a motion intended by the user. Under the circumstances, the top T(t):Y is regarded as the operating point and used as the indicated coordinates, thereby enabling the indicated coordinates of the operating point to be obtained according to the intention of the user. Information P(t) really output as the indicated coordinates indicative of the motion of the operating point is the travel distance as relative coordinates, or a value obtained by sequentially adding the travel distance to a value of the previous indicated coordinates.

As illustrated in FIG. 4, when the operation of tracing the touch pad with the thumb from bottom up is conducted, the touch region is changed in the order of TE4, TE5, and TE6 as indicated by FIGS, 4(A), 4(B), and 4(C). A center point (center of gravity) thereof is changed in the order of C4, C5, and C6. When the finger is going to be moved up, the thumb is first erected, and only a fingertip is brought in contact with the touch pad at the time of starting the operation as illustrated in FIG. 4(A). Therefore, the touch area becomes the minimum. Then, as illustrated in FIG. 4(B), when the finger is moved up, and the ball of the finger is pushed and lies on the touch pad. The finger is moved up while gradually enlarging the touch area. Then, as illustrated in FIG. 4(C), the finger further lies on the touch pad, and the contact area becomes the maximum.

FIG. 5 illustrates a change in the touch region corresponding to the operation of FIG. 4 with time. The axis of abscissa represents a time, and the axis of ordinates is coordinates of the vertical direction. In a change of the touch region TE, the motion of the indicated coordinates of the operating point which is detected by the sensor in the conventional touch pad corresponds to the motion of the center point C(t) which is the center of gravity in the touch region TE. In this case, when the center point C(t) is employed as the operating point, the motion becomes unstable due to a change in the touch region TE. Also, because the position of the center point C(t) is moved down with an enlargement of the touch region TE. Therefore, the travel distance becomes smaller when the operation is in the upper direction, and the operation response is deteriorated. On the contrary, in this embodiment, attention is paid to the motion of the top T(t), and the top T(t) is regarded as the operating point and used as the indicated coordinates, thereby enabling the indicated coordinates of the operating point to be obtained according to the intention of the user. The information P(t) really output as the indicated coordinates indicative of the motion of the operating point is the travel distance as relative coordinates, or a value obtained by sequentially adding the travel distance to a value of the previous indicated coordinates.

### First Embodiment

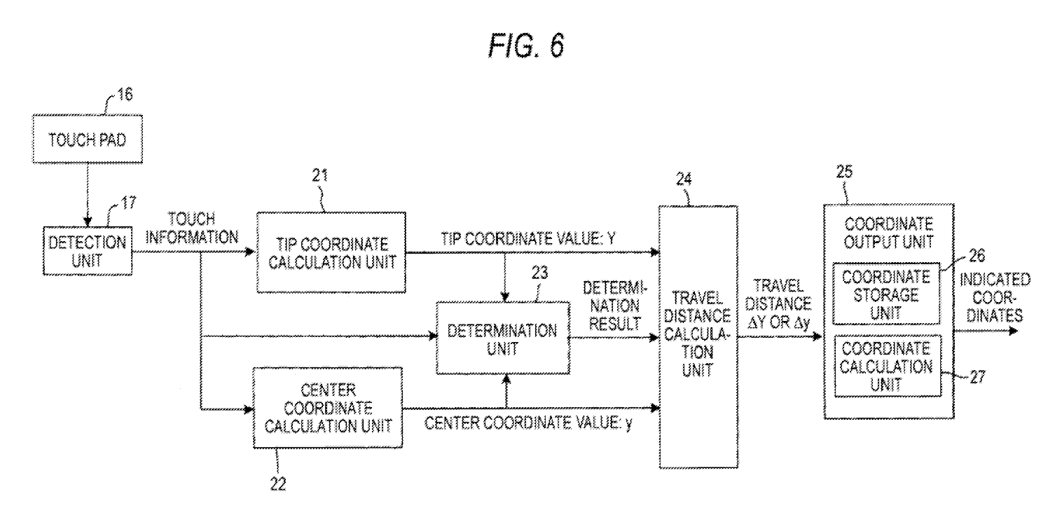

FIG. 6 is a block diagram illustrating a configuration of an operation input unit of a portable terminal device according to a first embodiment of the present invention. The portable terminal device includes a tip coordinate calculation unit 21, a center coordinate calculation unit 22, a determination unit 23, a travel distance calculation unit 24, and a coordinate output unit 25 as the coordinate correction unit 18 of the operation input unit 11.

The tip coordinate calculation unit 21 receives a touch information on a touch region of the touch pad 16 detected by the detection unit 17, calculates the coordinates of a top of the touch region as the coordinates of the touch region corresponding to a fingertip, and outputs the calculated coordinates as a tip coordinate value Y. A calculation unit of the tip coordinate value Y calculates the tip coordinates, for example, with the use of the top two values of the Y coordinate in the vertical direction among the outputs of respective electrodes within the detection area of the touch pad 16, which exceed a given threshold value. A portion of the touch pad in which the output of the electrode exceeds the given threshold value is detected as the touch region that is touched with the user's finger. Therefore, the largest value of the Y coordinate in the touch region can be regarded as the top of the touch region.

The center coordinate calculation unit 22 receives the touch information on the touch region of the touch pad 16 detected by the detection unit 17, calculates the coordinates of the center of gravity as the coordinates of the center of the touch region, and outputs the calculated coordinates as the center coordinate value y.

The determination unit 23 receives the touch information, the tip coordinate value Y, and the center coordinate value y, and determines whether the touch finger is moved, or not, and whether the touch finger is separate from the touch pad, or not, on the basis of a change in the width of the touch region, the motion of the tip, and the motion of the center.

The travel distance calculation unit 24 calculates the travel distance with the use of any one of the tip coordinate value Y and the center coordinate value y on the basis of the determination result of the determination unit 23, and outputs the travel distance AY or Ay. The coordinate output unit 25 includes a coordinate storage unit 26 that stores the indicated coordinates previously output therein, and a coordinate calculation unit 27 that adds the travel distance from the travel distance calculation unit 24 to the value of the stored previous indicated coordinates to calculate the indicated coordinate. The coordinate output unit 25 receives the travel distance calculated in the travel distance calculation unit 24, and calculates and outputs the indicated coordinates of the operating point added with the travel distance. In this situation, when it is assumed that the indicated coordinates of the last operating point are P(t−1), the coordinate output unit 25 outputs P(t)=P(t−1)+ΔY or P(t)=P(t−1)+Δy. As the output of the operation input unit 11 including the touch pad 16, the indicated coordinates P(t) of the operating point calculated in the coordinate output unit 25 may be output as the absolute coordinates, and the travel distance ΔY or Δy calculated in the travel distance calculation unit 24 may be output as the relative coordinates indicative of the operating amount.

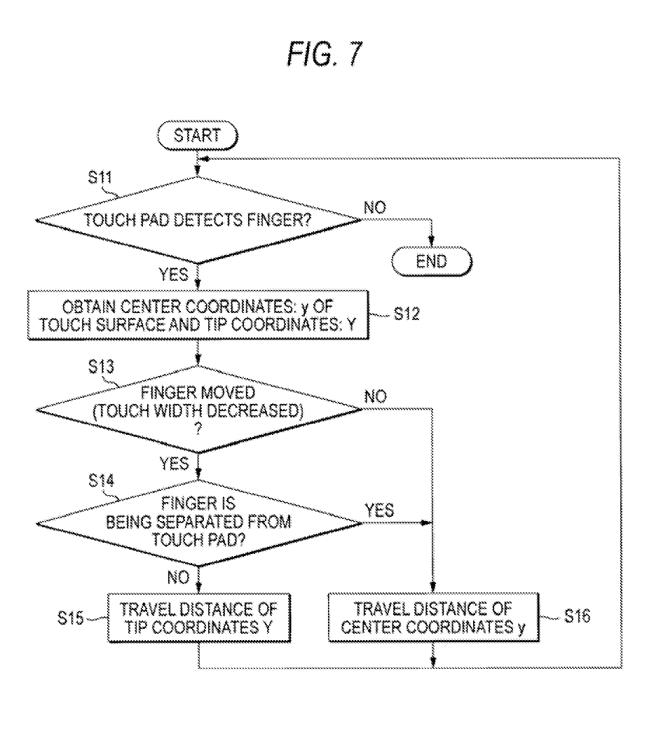

FIG. 7 is a flowchart illustrating the operation of the operation input unit according to the first embodiment. First, in the detection unit 17, it is determined whether there is the touch region, or not, according to the output of the touch pad 16, and it is determined whether the touch pad 16 detects the finger, or not (Step S11), In this situation, if the finger is not detected, the processing is completed, and if the finger is detected, the processing is advanced to subsequent processing. Then, with the use of the touch information detected by the detection unit 17, in the center coordinate calculation unit 22, the center coordinate value y is calculated, and in the tip coordinate calculation unit 21, the tip coordinate value Y is calculated (Step S12).

Then, in the determination unit 23, it is determined whether the finger touching the touch pad is moved, or not, that is, the touch region travels, or not (Step 13). Whether the touch finger moves, or not, is determined, for example, according to whether the touch width indicative of the width of the touch region (in this example, the width in the vertical direction) is decreased, or not. When the finger is moved in the vertical direction, the area of the touch region is changed as described above, and the vertical width fluctuates. In particular, when the finger is moved in the lower direction, because the touch width is decreased, the motion of the finger can be determined according to a change in the width of the touch region. Also, whether the touch finger moves, or not, is determined, for example, according to the movement of the tip or center coordinate of the area of the touch region.

In Step S13, if the finger that touches the touch pad is moving, it is further determined in the determination unit 23 whether the touch finger is being separated from the touch pad, or not (Step S14). Whether the finger is separated from the touch pad, or not, is determined, for example, according to whether the touch area is smaller than a given value, or not, that is, whether the touch width is smaller than the given value, or not. In this example, when the finger is moved by a given amount or more, and the finger is not being separated from the touch pad, as processing when the operating finger moves, in the travel distance calculation unit 24, the travel distance ΔY is calculated with the use of the tip coordinate value Y, and the travel distance ΔY is output (Step S15). With the use of the tip coordinates when the finger moves, the motion according to the user's intention can be detected.

On the other hand, in Step S13, when the finger that touches the touch pad is not moved, as processing when the operating finger stops, in the travel distance calculation unit 24, the travel distance Δy is calculated with the use of the center coordinate value y, and the travel distance Δy is output (Step S16). Also, in Step S14, when the finger is being separated from the touch pad, as processing when the operating finger is separated from the touch pad, in Step S16, the travel distance Δy is calculated with the use of the center coordinate value y in the travel distance calculation unit 24, and the travel distance Δy is output. Also, at a touch start time when the finger starts to touch the touch pad, the travel distance Δy is calculated with the use of the center coordinate value y like the separation time. At the stop time, the separating time, and the touch start time of the finger, with the use of the center coordinates which are substantially unmoved, the stable indicated coordinates without unnecessary motion can be obtained, and the coordinates of the appropriate operating point can be detected. At the separating time or the touch start time, if the width or area of the touch region is smaller than a first given value, the travel distance is calculated with the use of the center coordinates. Alternatively, if the width or area of the touch region is smaller than a second given value smaller than the first given value, the travel distance is not added. Thus, various modification examples are conceivable in the calculation processing of the travel distance.

As described above, in this embodiment, when the finger that touches the touch pad is moved, the travel distance is calculated with the use of the tip coordinates of the touch region. At the stop time, the separating time, and the touch start time of the finger, the travel distance is calculated with the use of the center coordinates of the touch region. With the above configuration, at each time when the finger is moved and stopped, the travel distance according to the motion intended by the user can be output to obtain the indicated coordinate of the operating point. When the operation of tracing the touch pad with the finger from top down is conducted, a drawback that the operating point is moved in the opposite direction once can be eliminated, and an operation input suitable for the user's feeling can be conducted. Also, similarly, when the touch pad is traced with the finger from bottom up, the operating point can approach the motion intended by the user, and a response to the operation can be improved. Also, with the use of the tip coordinates and the center coordinate, as compared with a case in which the representative coordinates are calculated on the basis of the increase rate of the area of the touch region, and the distance and direction when the touch region travels, the travel distance and the indicated coordinates of the operating point can be obtained with simple processing.

Therefore, according to this embodiment, the travel distance and the indicated coordinates of the operating point can be calculated with simple processing, the input indication corresponding to the operation intended by the user can be conducted, and the response to the operation can be improved. With the above configuration, the operability of the touch pad can be enhanced, and the usability of the portable terminal device can be improved.

### Second Embodiment

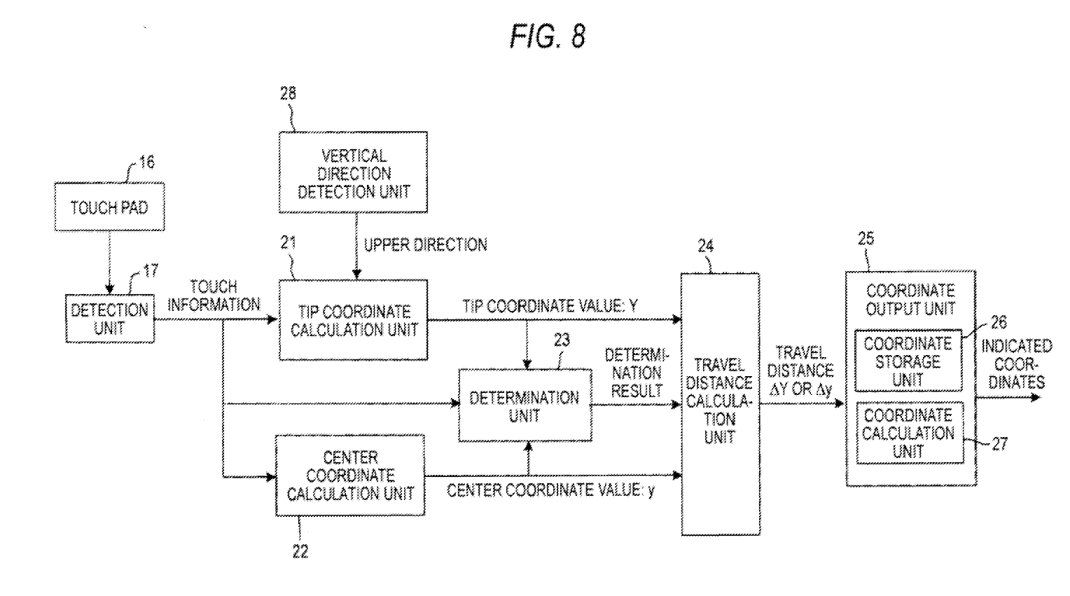

FIG. 8 is a block diagram illustrating a configuration of an operation input unit of a portable terminal device according to a second embodiment of the present invention. In the second embodiment, a vertical direction detection unit 28 is provided in addition to the configuration of the first embodiment illustrated in the first embodiment illustrated in FIG. 6.

The vertical direction detection unit 28 detects an upper direction of the touch pad 16 by detection of the vertical direction of a housing or a display unit when the user grips and operates the portable terminal device, and outputs the information on the upper direction to the tip coordinate calculation unit 21. The tip coordinate calculation unit 21 calculates the tip coordinate value Y on the basis of the upper direction of the touch pad detected by the vertical direction detection unit 28. As the unit that detects the vertical direction, in the case of the folding portable terminal device that can be opened or closed in plural directions such vertical opening or horizontal opening, there is provided an open/close direction detecting unit that detects a direction of opening and closing the housing by a hinge, and the upper direction of the display unit including the touch pad is determined according to the open/close direction. In this example, in the case of the vertical opening, an upper direction of the display part when the portable terminal device is gripped and operated in the vertical opening such as the longitudinal direction of the housing is determined as the upper direction. Also, in the case of the lateral opening, with the opening direction set as the upper direction, and an upper direction of the display unit when the portable terminal device is gripped and operated in the lateral opening is determined as the upper direction. In the portable terminal device of the slide type or with no open/close mechanism, an acceleration detection unit such as an acceleration sensor or a gyro is used as a vertical direction detection unit, and the vertical direction of the housing or the display unit is detected so as to detect the upper direction of the touch pad.

As described above, in the second embodiment, the upper direction of the touch pad is detected, thereby enabling the tip coordinates of the touch region to be appropriately calculated. Accordingly, in addition to the advantage of the first embodiment, the travel distance during the operation and the detection precision of the operating point can be improved, and the operability can be further improved.

The present invention is not limited to the above embodiments, but modifications and applications by an ordinary skilled person on the basis of the disclosure of the present specification and known techniques are intended by the present invention, and included in a scope to be protected. Also, the respective components in the above embodiments may be arbitrarily combined together without departing from the subject matter of the present invention.

In the above-described embodiments, only the vertical direction of the touch pad is illustrated. The same processing is conducted on the horizontal direction, and the indicated coordinates using the tip coordinates (coordinates of the end of the touch region) in two directions consisting of the vertical direction and the horizontal direction can be output. Alternatively, the indicated coordinates may be output by using the center coordinates in the horizontal direction, and the processing in the horizontal direction is arbitrary. That is, the indicated coordinates using the tip coordinates are output only in the vertical direction, and the indicated coordinates using the center coordinates are output in the horizontal direction. Thus, two kinds of processing may be combined together. The processing for outputting the indicated coordinates with the use of the tip coordinates in both of the vertical direction and the horizontal direction may be applied.

The present invention is based on Japanese Patent Application No. 2009-047926 filed on Mar. 2, 2009, and the contents of which are incorporated herein by reference.

### INDUSTRIAL APPLICABILITY

The present invention has advantages that the input indication corresponding to the operation intended by the user in the touch pad can be conducted, and the operability can be improved. The present invention is useful as the portable terminal device having the touch pad for conducting the input indication, and the input device including the touch pad.

### DESCRIPTION OF REFERENCE SYMBOLS

11, operation input unit

12, display unit

13, control unit

14, communication unit

15, voice processing unit

16, touch pad

17, detection unit

18, coordinate correction unit

21, tip coordinate calculation unit

22, center coordinate calculation unit

23, determination unit

24, travel distance calculation unit

25, coordinate output unit

26, coordinate storage unit

27, coordinate calculation unit

28, vertical direction detection unit

1. A portable terminal device having a touch pad, comprising:
a detection unit that detects a touch region on the touch pad;
a tip coordinate calculation unit that calculates tip coordinates of the touch region;
a center coordinate calculation unit that calculates center coordinates of the touch region;
a determination unit that determines whether the touch region travels or not;
a travel distance calculation unit that calculates a travel distance by the use of any one of the tip coordinates and the center coordinates on the basis of a determination result of the determination unit; and
a coordinate output unit that outputs indicated coordinates for indicating a specific position corresponding to the touch operation on the touch pad with the use of the calculated travel distance.

2. The portable terminal device according to claim 1, wherein the coordinate output unit includes a coordinate storage unit that stores the indicated coordinates therein, and a coordinate calculation unit which adds the travel distance calculated with the use of any one of the tip coordinates and the center coordinates to the indicated coordinates.

3. The portable terminal device according to claim 1, wherein the travel distance calculation unit calculates the travel distance with the use of the tip coordinates when the touch region travels by a given amount or greater, and calculates the travel distance with the use of the center coordinates when the travel distance of the touch region is smaller than the given amount.

4. The portable terminal device according to claim 3, wherein the travel distance calculation unit calculates the travel distance with the use of the center coordinates when a width or area of the touch region is smaller than a first given value.

5. The portable terminal device according to claim 4, wherein the travel distance calculation unit does not add the travel distance when the width or area of the touch region is smaller than a second given value which is smaller than the first given value.

6. The portable terminal device according to claim 1, further comprising:
a vertical direction detection unit that detects a vertical direction of the touch pad,
wherein the tip coordinate calculation unit calculates the tip coordinates of the touch region on the basis of upper information detected by the vertical direction detection unit.

7. An input device for an electronic device having a touch pad, comprising:
a detection unit that detects a touch region on the touch pad;
a tip coordinate calculation unit that calculates tip coordinates of the touch region;
a center coordinate calculation unit that calculates center coordinates of the touch region;
a determination unit that determines whether the touch region travels or not;
a travel distance calculation unit that calculates a travel distance by the use of any one of the tip coordinates and the center coordinates on the basis of a determination result of the determination unit; and
a coordinate output unit that outputs indicated coordinates for indicating a specific position corresponding to the touch operation on the touch pad with the use of the calculated travel distance.
